(19) United States
(12) Patent Application Publication
(10) Pub. No.: US 2023/0391363 A1
(43) Pub. Date: Dec. 7, 2023

(54) USER-CONTROLLED ROUTE SELECTION FOR AUTONOMOUS VEHICLES

(71) Applicant: Waymo LLC, Mountain View, CA (US)

(72) Inventors: Carl Yang, Sunnyvale, CA (US); Celia Zhang, Sunnyvale, CA (US); Victor Chan, Mountain View, CA (US); Lauren Schwendimann, Burlingame, CA (US); Kevin Malta, San Francisco, CA (US); Sahil Bahri, San Jose, CA (US); Austin Abrams, Redwood City, CA (US)

(21) Appl. No.: 17/830,021

(22) Filed: Jun. 1, 2022

(51) Int. Cl. B60W 60/00; G01C 21/34

(52) U.S. Cl. CPC B60W 60/0011; G01C 21/3484; B60W 2540/215

(57) ABSTRACT

Aspects of the disclosure relate to controlling an autonomous vehicle. For instance, dispatching instructions including a destination location and a trip plan identifying a selected route may be received. The route was selected by a user from a set of two or more routes. The trip plan may be used to determine whether to user the selected route or a new route. The autonomous vehicle may be controlled to the destination location based on the determination.

### BACKGROUND

Autonomous vehicles for instance, vehicles that may not require a human driver, can be used to aid in the transport of passengers or items from one location to another. Such vehicles may operate in a fully autonomous mode where passengers may provide some initial input, such as a pickup or destination location, and the autonomous vehicle maneuvers itself to that location. Autonomous vehicles are equipped with various types of sensors in order to detect objects in the surroundings. For example, autonomous vehicles may include sonar, radar, camera, Lidar, and other devices that scan, generate and/or record data about the vehicle's surroundings in order to enable the autonomous vehicle to plan trajectories in order to maneuver itself through the surroundings.

### BRIEF SUMMARY

Aspects of the disclosure provide a method of controlling an autonomous vehicle. The method includes receiving, by one or more processors, dispatching instructions including a destination location and a trip plan identifying aspects of a selected route, wherein the selected route was selected by a user from a set of two or more routes; using, by the one or more processors, the trip plan to plan a route locally at the autonomous vehicle; and controlling, by the one or more processors, the autonomous vehicle to the destination location based on the planned route.

In one example, the trip plan further identifies a plurality of identifiers for road segments which when connected together with a pickup location and the destination location correspond to the selected route. In another example, the trip plan further identifies a plurality of geographic locations which when connected together with a pickup location and the destination location correspond to the selected route. In this example, two or more of the plurality of geographic locations are a fixed distance from one another. In another example, the trip plan further identifies a geographic location between a pickup location and the destination location on the selected route, and the method further comprises: generating routes based on a current location of the autonomous vehicle and the destination location; and determining costs for the generated routes by adding an additional cost to each of the generated routes which do not pass through the identified geographic location, and wherein determining whether to use the selected route or a new route is based on the determined costs. In another example, the trip plan further identifies a geographic location between a pickup location and the destination location for each route of the set of routes, and the method further comprises: generating routes based on a current location of the autonomous vehicle and the destination location; and determining costs for the generated routes by adding an additional cost to each of the generated routes which pass through the identified geographic locations for routes of the set of routes other than the selected route, and wherein determining whether to use the selected route or a new route is based on the determined costs. In another example, the trip plan further identifies a plurality of geographic locations for each given route of the set of routes which when connected together with a pickup location and the destination location correspond to the given route, and the method further comprises: generating routes based on a current location of the autonomous vehicle and the destination location; and determining costs for the generated routes by adding an additional cost to each of the generated routes which pass within a radial distance of any of the identified geographic locations for routes of the set of routes, and wherein determining whether to use the selected route or a new route is based on the determined costs. In another example, the trip plan further identifies a plurality of geographic locations for each given route of the set of routes which when connected together with a pickup location and the destination location correspond to the given route, and the method further comprises: generating routes based on a current location of the autonomous vehicle and the destination location; and determining costs for the generated routes by adding an additional cost to each of the generated routes which pass within a radial distance of any of the identified geographic locations for routes of the set of routes other than the selected route, and wherein determining whether to use the selected route or a new route is based on the determined costs. In another example, the trip plan further identifies a geographic location between a pickup location and the destination location on the selected route, and the method further comprises: generating routes based on a current location of the autonomous vehicle and the destination location; and determining costs for the generated routes by adding a negative cost to each of the generated routes which pass through the identified geographic location, and wherein determining whether to use the selected route or a new route is based on the determined costs.

Another aspect of the disclosure provides a system for controlling an autonomous vehicle. The system includes one or more processors configured to: receive dispatching instructions including a destination location and a trip plan identifying a selected route, wherein the selected route was selected by a user from a set of two or more routes; use the trip plan to plan a route locally at the autonomous vehicle; and control the autonomous vehicle to the destination location based on the determination.

In one example, the trip plan further identifies a plurality of identifiers for road segments which when connected together with a pickup location and the destination location correspond to the selected route. In another example, the trip plan further identifies a plurality of geographic locations which when connected together with a pickup location and the destination location correspond to the selected route. In this example, two or more of the plurality of geographic locations are a fixed distance from one another. In another example, the trip plan further identifies a geographic location between a pickup location and the destination location on the selected route, and the one or more processors are further configured to: generate routes based on a current location of the autonomous vehicle and the destination location; and determine costs for the generated routes by adding an additional cost to each of the generated routes which do not pass through the identified geographic location, and wherein determining whether to use the selected route or a new route is based on the determined costs. In another example, the trip plan further identifies a geographic location between a pickup location and the destination location for each route of the set of routes, and the one or more processors are further configured to: generate routes based on a current location of the autonomous vehicle and the destination location; and determine costs for the generated routes by adding an additional cost to each of the generated routes which pass through the identified geographic locations for routes of the set of routes other than the selected route, and wherein determining whether to use the selected route or a new route is based on the determined costs. In another example, the trip plan further identifies a plurality of geographic locations for each given route of the set of routes which when connected together with a pickup location and the destination location correspond to the given route, and the one or more processors are further configured to: generate routes based on a current location of the autonomous vehicle and the destination location; and determine costs for the generated routes by adding an additional cost to each of the generated routes which pass within a radial distance of any of the identified geographic locations for routes of the set of routes, and wherein determining whether to use the selected route or a new route is based on the determined costs. In another example, the trip plan further identifies a plurality of geographic locations for each given route of the set of routes which when connected together with a pickup location and the destination location correspond to the given route, and the one or more processors are further configured to: generate routes based on a current location of the autonomous vehicle and the destination location; and determine costs for the generated routes by adding an additional cost to each of the generated routes which pass within a radial distance of any of the identified geographic locations for routes of the set of routes other than the selected route, and wherein determining whether to use the selected route or a new route is based on the determined costs. In another example, the trip plan further identifies a geographic location between a pickup location and the destination location on the selected route, and the one or more processors are further configured to: generate routes based on a current location of the autonomous vehicle and the destination location; and determine costs for the generated routes by adding a negative cost to each of the generated routes which pass through the identified geographic location, and wherein determining whether to use the selected route or a new route is based on the determined costs. In another example, the system also includes the autonomous vehicle. In another example, the system also includes one or more server computing devices including one or more processors configured to send the dispatching instructions to the one or more processors, and wherein the one or more processors are part of the autonomous vehicle.

### BRIEF DESCRIPTION OF THE DRAWINGS

FIG. 1 is a functional diagram of an example vehicle in accordance with an exemplary embodiment.

FIGS. 2A-2B is an example of map information in accordance with aspects of the disclosure.

FIG. 3A-3B are example external views of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIG. 6 is an example representation of forward and backward searches of map information in accordance with aspects of the disclosure.

FIG. 7 is an example representation of forward and backward searches of map information and vias in accordance with aspects of the disclosure.

FIG. 8 is an example client device, a map, and routes in accordance with aspects of the disclosure.

FIG. 9 is an example client device, a map, and a selected route in accordance with aspects of the disclosure.

FIG. 10 is an example of an enforcement approach in accordance with aspects of the disclosure.

FIG. 11 is an example of an enforcement approach in accordance with aspects of the disclosure.

FIG. 12 is an example of an enforcement approach in accordance with aspects of the disclosure.

FIG. 13 is an example of an enforcement approach in accordance with aspects of the disclosure.

FIG. 14 is an example client device and a notification in accordance with aspects of the disclosure.

FIG. 15 is an example flow diagram in accordance with aspects of the disclosure.

### DETAILED DESCRIPTION

### Overview

The technology relates to enabling passengers to select routes for an autonomous vehicle to follow as well as enforcing those selected routes while at the same time enabling autonomous vehicles to deviate from the selected routes when necessary. While with a typical transportation service using road vehicles, the passenger and driver may discuss a preferred route and/or necessary deviations from a route, and the driver may proceed accordingly. However, with a transportation service that utilizes autonomous vehicles, there is no driver. While some services may allow users or passengers to select a preferred route, when an autonomous vehicle is able to reroute itself in real time, enforcing the passenger's preferred route while at the same time enabling autonomous vehicles to deviate from the preferred route may be critical to the passenger's satisfaction with the transportation service and encouraging future ridership.

In order to do so, when a user sets up a trip, the user may select from a set of possible routes. For instance, the user may use a client computing device to provide a pickup location and a destination location to one or more server computing devices. These server computing devices may use the locations to determine a set of routes. Typically, the routing system of the server computing devices may search for an optimal route between two locations which has the best (e.g., lowest) overall cost based on a combination of attributes (e.g., shortest route with the least amount of turns where the autonomous vehicle reaches a location on the desired side of the street, avoid difficult maneuvers like three-point turns, etc.). In order to generate alternative routes that differ from the optimal route in a non-trivial way, the alternative routes may be selected based on specific attributes. For example, in addition to the optimal route, the set of routes may also include routes that have the fewest number of turns, shortest route in terms of time, shortest route in terms of driving distance, etc.

In some instances, the set of routes may be determined based on the alternative routes that are generated automatically when performing the route searches by the routing system to find the optimal route. For example, one algorithm may perform a plurality of forward searches from the pickup location and reverse searches from the destination location on map information in order to identify locations or graph nodes where the searches meet or “vias”. These vias may form the basis of the set of routes. For instance, for each via the shortest path from the pickup location to the via and from the via to the destination location may be a single route.

Different approaches may be used in order to limit the number of routes in the set of routes. For instance, the optimal route may always be included in the set and various combinations of different requirements may be used to exclude or filter routes that are too similar or otherwise not desirable. For another instance, routes which are otherwise not desirable because they are simply too long or require certain types of maneuvers may be excluded or filtered.

Other attributes may be used to include a particular alternative route in the set of routes. For example, the optimal route, or the route with the lowest cost, may be included in the set of routes. In addition, routes that have been selected by this user or other users of the transportation service in the past may be included.

The server computing devices may send the set of routes to the user's client computing device for display. In some instances, the routes may be displayed with attributes for each route. The user may select one of the routes or alternatively, if a route is not affirmatively selected, a default route may be automatically selected. In this regard, users who prefer not to select a particular route may not be required to do so. The client computing device may then send a signal to the server computing device identifying the selected route.

The server computing devices may then send dispatching instructions to an autonomous vehicle to cause the autonomous vehicle to travel to the pickup location in order to pick up the user (now passenger) and transport the passenger to the destination location. The server computing devices may also provide the autonomous vehicle with a trip plan. The trip plan may include information that can be used by the autonomous vehicle to determine the route.

Alternatively, the information of the trip plan may include a list of geographic locations (e.g., points corresponding to locations within map information, such as latitude and longitude coordinates or other map coordinates) which when connected in order with the pickup location, via, and destination location correspond to the route. This may be especially useful in situations in which the map information is continuously updated and the road segments and identifiers may be changed over time.

The autonomous vehicle may then use the trip plan to route between the pickup location and destination location. However, because the autonomous vehicle has its own routing system that the autonomous vehicle may use periodically to recalculate the optimal route, if the selected route is not or no longer the optimal route, the autonomous vehicle may deviate from the selected route. To avoid this, different enforcement approaches may be used.

Because the rerouting may occur while the user (now passenger) is within the autonomous vehicle, when a new route is published by the routing system, the autonomous vehicle's computing devices may automatically provide a notification, for example, on an internal display of the autonomous vehicle to indicate the change.

The features described herein may enable passengers to select routes for an autonomous vehicle to follow as well as enforce those selected routes while at the same time enabling autonomous vehicles to deviate from the selected routes when necessary. Because multiple different routes are provided to a user at the time a trip is arranged, the transportation service is more likely to present the user with a route that the user likes. This may therefore account for a user's personal preferences and may also provide the user with some feeling and actual control over the trip beyond the pickup and destination locations. Moreover, the different approaches provided herein may enable flexible enforcement of a selected route which meets the needs of a particular transportation service.

### Example Systems

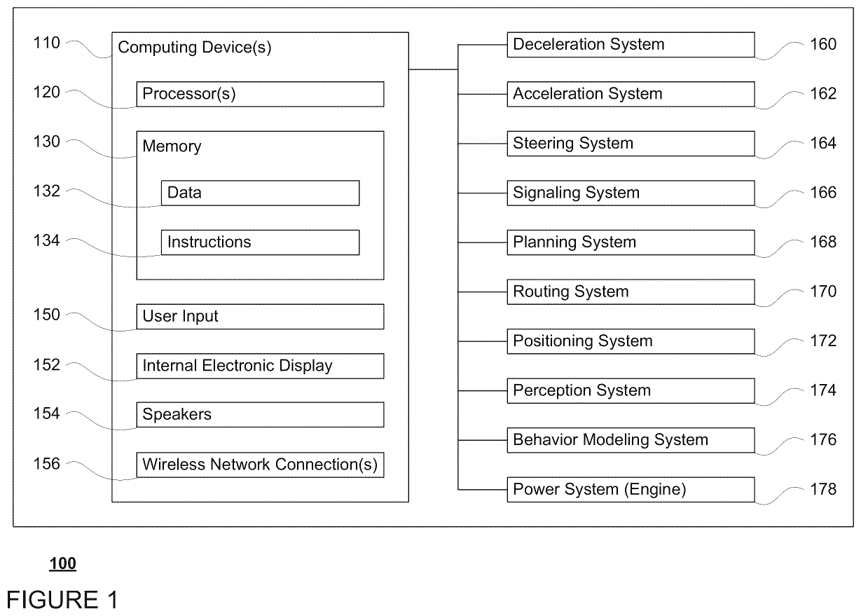

As shown in FIG. 1, an autonomous vehicle 100 in accordance with one aspect of the disclosure includes various components. Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. An autonomous vehicle may also operate in one or more autonomous driving modes including, for example, a semi or partially autonomous driving mode in which a person exercises some amount of direct or remote control over driving operations, or a fully autonomous driving mode in which the vehicle handles the driving operations without direct or remote control by a person. These vehicles may be known by different names including, for example, autonomously driven vehicles, self-driving vehicles, and so on.

The U.S. National Highway Traffic Safety Administration (NHTSA) and the Society of Automotive Engineers (SAE) have each identified different levels to indicate how much, or how little, a vehicle controls the driving, although different organizations may categorize the levels differently. Moreover, such classifications may change (e.g., be updated) overtime.

As described herein, in a semi or partially autonomous driving mode, even though the vehicle assists with one or more driving operations (e.g., steering, braking and/or accelerating to perform lane centering, adaptive cruise control or emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

In contrast, in a fully autonomous driving mode, the control system of the vehicle performs all driving tasks and monitors the driving environment. This may be limited to certain situations such as operating in a particular service region or under certain time or environmental restrictions, or may encompass driving under all conditions without limitation. In a fully autonomous driving mode, a person is not expected to take over control of any driving operation.

Unless indicated otherwise, the architectures, components, systems and methods described herein can function in a semi or partially autonomous driving mode, or a fully-autonomous driving mode.

While certain aspects of the disclosure are particularly useful in connection with specific types of vehicles, the vehicle may be any type of vehicle including, but not limited to, cars, trucks (e.g. garbage trucks, tractor-trailers, pickup trucks, etc.), motorcycles, buses, recreational vehicles, street cleaning or sweeping vehicles, etc. The vehicle may have one or more computing devices, such as computing device 110 containing one or more processors 120, memory 130 and other components typically present in general purpose computing devices.

The memory 130 stores information accessible by the one or more processors 120, including data 132 and instructions 134 that may be executed or otherwise used by the processor 120. The memory 130 may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processors 120 may be any conventional processors, such as commercially available CPUs or GPUs. Alternatively, the one or more processors may include a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., one or more of a button, mouse, keyboard, touch screen and/or microphone), various electronic displays (e.g., a monitor having a screen or any other electrical device that is operable to display information), and speakers 154 to provide information to a passenger of the autonomous vehicle 100 or others as needed. For example, internal display 152 may be located within a cabin of autonomous vehicle 100 and may be used by computing devices 110 to provide information to passengers within the autonomous vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Computing devices 110 may be part of an autonomous control system for the autonomous vehicle 100 and may be capable of communicating with various components of the vehicle in order to control the vehicle in an autonomous driving mode. For example, returning to FIG. 1, computing devices 110 may be in communication with various systems of autonomous vehicle 100, such as deceleration system 160, acceleration system 162, steering system 164, signaling system 166, planning system 168, routing system 170, positioning system 172, perception system 174, behavior modeling system 176, and power system 178 in order to control the movement, speed, etc. of autonomous vehicle 100 in accordance with the instructions 134 of memory 130 in the autonomous driving mode.

As an example, computing devices 110 may interact with deceleration system 160 and acceleration system 162 in order to control the speed of the vehicle. Similarly, steering system 164 may be used by computing devices 110 in order to control the direction of autonomous vehicle 100. For example, if autonomous vehicle 100 is configured for use on a road, such as a car or truck, steering system 164 may include components to control the angle of wheels to turn the vehicle. Computing devices 110 may also use the signaling system 166 in order to signal the vehicle's intent to other drivers or vehicles, for example, by lighting turn signals or brake lights when needed.

Routing system 170 may be used by computing devices 110 in order to generate a route to a destination location using map information. Planning system 168 may be used by computing device 110 in order to generate short-term trajectories that allow the vehicle to follow routes generated by the routing system. In this regard, the planning system 168 and/or routing system 166 may store detailed map information, e.g., pre-stored, highly detailed maps identifying a road network including the shape and elevation of roadways, lane lines, intersections, crosswalks, speed limits, traffic signals, buildings, signs, real time traffic information (updated as received from a remote computing device), pullover spots, vegetation, or other such objects and information.

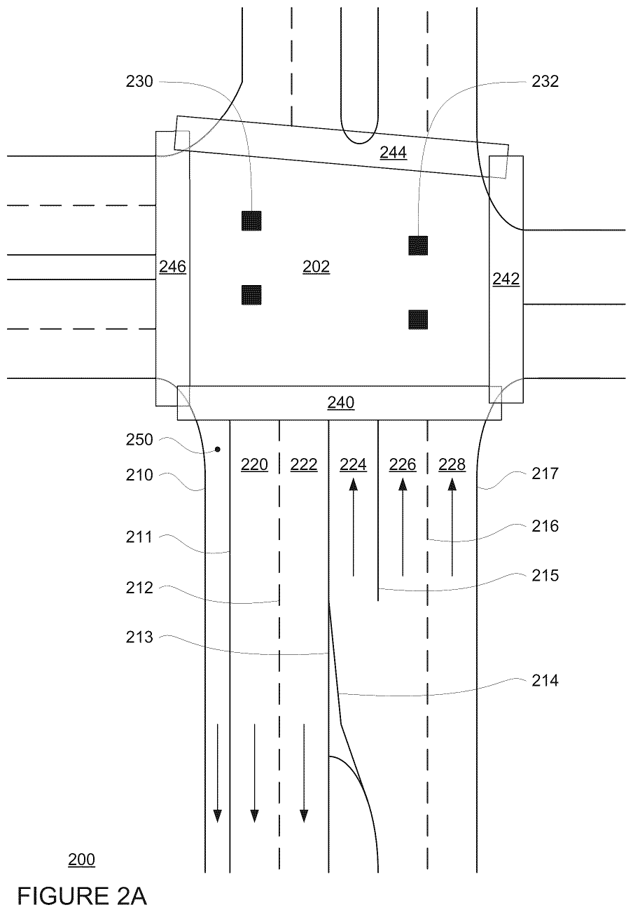

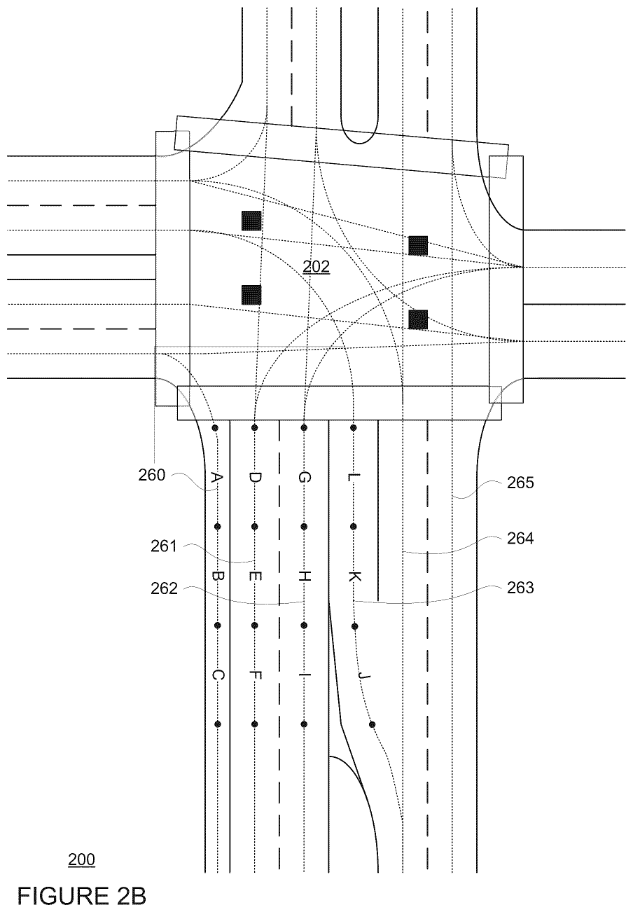

FIGS. 2A and 2B is an example of map information 200 for a small section of roadway including intersection 202. FIG. 2A depicts a portion of the map information 200 that includes information identifying the shape, location, and other characteristics of lane markers or lane lines 210, 211, 212, 213, 214, 215, 216, 217 which define the boundaries of lanes 220, 222, 224, 226, 228, as well as shoulder area 250. In this regard, some areas which may not necessarily be lanes (e.g., shoulder areas) may be identified as drivable areas (e.g., lanes). In this example, the map information also includes other features of intersection 202 such as traffic control devices including traffic signal lights 230, 232, as well as crosswalk areas 240, 242, 244, 246. In addition to the aforementioned features and information, the map information may also include information that identifies the direction of traffic for each lane (represented by arrows in FIG. 2A) as well as information that allows the computing devices 110 to determine whether the vehicle has the right of way to complete a particular maneuver (i.e., complete a turn or cross a lane of traffic or intersection). In this regard, the map information 200 may identify various features which the autonomous vehicle 100's systems may use to localize the autonomous vehicle as well as to generate routes to a destination and trajectories to follow in order to reach that destination.

The map information may be configured as a roadgraph. The roadgraph may include a plurality of graph nodes and edges representing features such as crosswalks, traffic lights, road signs, road or lane segments, etc., that together make up the road network of the map information. Each edge is defined by a starting graph node having a specific geographic location (e.g., latitude, longitude, altitude, etc.), an ending graph node having a specific geographic location (e.g., latitude, longitude, altitude, etc.), and a direction. This direction may refer to a direction the autonomous vehicle 100 must be moving in in order to follow the edge (i.e., a direction of traffic flow). The graph nodes may be located at fixed or variable distances. For instance, the spacing of the graph nodes may range from a few centimeters to a few meters and may correspond to the speed limit of a road on which the graph node is located. In this regard, greater speeds may correspond to greater distances between graph nodes. The edges may represent driving along the same driving lane or changing driving lanes. Each node and edge may have a unique identifier, such as a specific code, map location, or a latitude and longitude location of the node or starting and ending locations or nodes of an edge. In addition to nodes and edges, the map may identify additional information such as types of maneuvers required at different edges as well as which lanes are drivable.

FIG. 2B includes a few example representations (not all) of the aforementioned nodes and edges corresponding to a portion of the map information 200. These nodes, when linked together, may form paths within lanes that the autonomous vehicle can follow to correctly position itself within a lane and/or through an intersection (e.g., intersection 202). As shown in FIG. 2B, paths 260, 261, 262, 263, 264, 265 are represented by dashed lines. Each of these paths corresponds to a respective lane or shoulder area. For example, path 260 corresponds to shoulder area 250, path 261 corresponds to lane 220, path 262 corresponds to lane 222, path 263 corresponds to lane 224, path 264 corresponds to lane 226, and path 265 corresponds to lane 228.

These paths may be formed by following edges between nodes in the aforementioned roadgraph. As an example, an edge may correspond to a segment of drivable road surface. For instance, as shown in FIG. 2B, a plurality of edges A, B, C, D, E, F, G, H, I, J, K, L are depicted. In this example, edges A, B, C which represent a portion of path 260, edges D, E, F represent a portion of path 261, edges G, H, I represent a portion of path 262, and edges J, K, L represent a portion of path 263.

Each of these edges has an overlapping starting and/or end node with an adjacent edges depending upon the direction of the lane to which the edge corresponds. For example, the ending node of edge A is the starting node of edge B, the ending node of edge B is the starting node of edge C, etc. The ending node of edge D is the starting node of edge E, the ending node of edge E is the starting node of edge F, etc. The ending node of edge G is the starting node of edge H, the ending node of edge H is the starting node of edge I, etc. The ending node of edge J is the starting node of edge K, the ending node of edge K is the starting node of edge L, etc. And so on.

The routing system 166 may use the aforementioned map information to determine a route from a current location (e.g., a location of a current node) to a destination location. Routes may be generated using a cost-based analysis which attempts to select a route to the destination location with the lowest cost. Costs may be assessed in any number of ways such as time to the destination location, distance traveled (each edge may be associated with a cost to traverse that edge), types of maneuvers required, convenience to passengers or the vehicle, etc. Each route may include a list of a plurality of nodes and edges which the vehicle can use to reach the destination location. Routes may be recomputed, as discussed further below, periodically as the vehicle travels to the destination location.

The map information used for routing may be the same or a different map as that used for planning trajectories. For example, the map information used for planning routes not only requires information on individual driving lanes, but also the nature of driving and bicycle lane boundaries (e.g., solid white, dash white, solid yellow, etc.) to determine where lane changes are allowed. However, unlike the map used for planning trajectories, the map information used for routing need not include other details such as the locations of crosswalks, traffic lights, stop signs, etc., though some of this information may be useful for routing purposes. For example, between a route with a large number of intersections with traffic controls (such as stop signs or traffic signal lights) versus one with no or very few traffic controls, the latter route may have a lower cost (e.g., because it is faster) and therefore be preferable.

Positioning system 170 may be used by computing devices 110 in order to determine the vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude, a location of a node or edge of the roadgraph as well as relative location information, such as location relative to other cars immediately around it, which can often be determined with less noise than the absolute geographical location.

The positioning system 172 may also include other devices in communication with computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 174 also includes one or more components for detecting objects external to the vehicle such as other road users (vehicles, pedestrians, bicyclists, etc.) obstacles in the roadway, traffic signals, signs, trees, buildings, etc. For example, the perception system 174 may include Lidars, sonar, radar, cameras, microphones and/or any other detection devices that generate and/or record data which may be processed by the computing devices of computing devices 110. In the case where the vehicle is a passenger vehicle such as a minivan or car, the vehicle may include Lidar, cameras, and/or other sensors mounted on or near the roof, fenders, bumpers or other convenient locations.

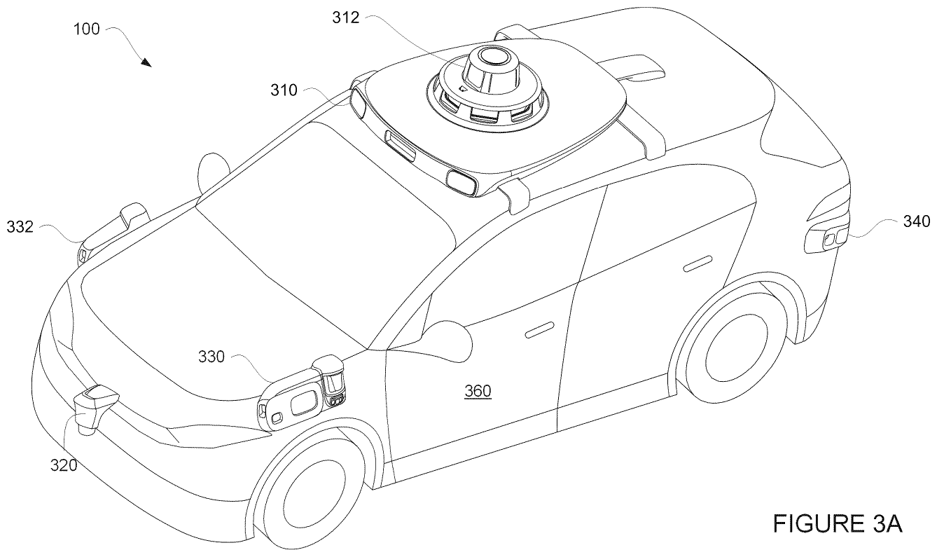

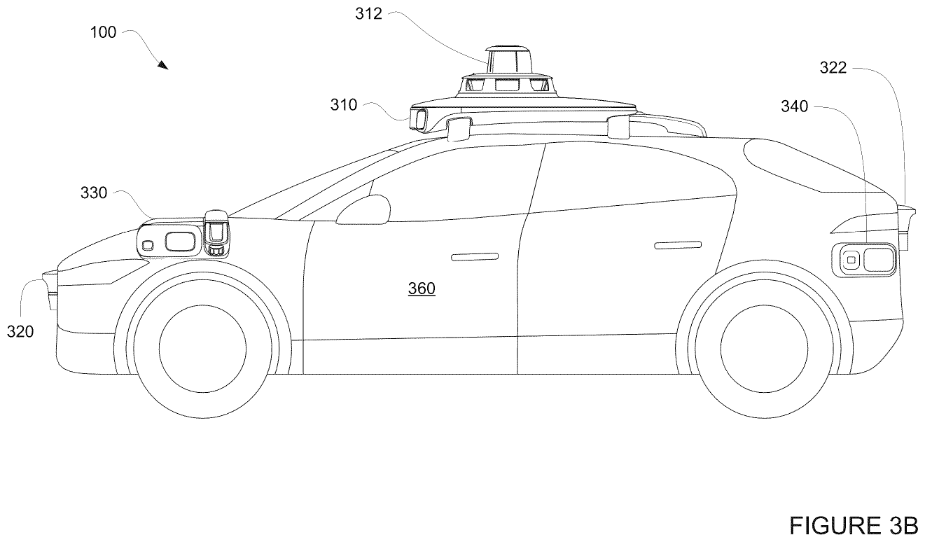

For instance, FIGS. 3A-3C are an example external views of autonomous vehicle 100. In this example, the roof of the autonomous vehicle includes a rooftop housing 310 and upper housing 312 may include a Lidar sensor as well as various cameras and radar units. Upper housing 312 may include any number of different shapes, such as domes, cylinders, “cake-top” shapes, etc. In addition, housing 320, 322 (shown in FIG. 3B) located at the front and rear ends of autonomous vehicle 100 and housings 330, 332 on the driver's and passenger's sides of the vehicle may each store a Lidar sensor and, in some instances, one or more cameras. For example, housing 330 is located in front of driver door 360. Autonomous vehicle 100 also includes a housing 340 for radar units and/or cameras located on the driver's side of the autonomous vehicle 100 proximate to the rear fender and rear bumper of autonomous vehicle 100. Another corresponding housing (not shown may also be arranged at the corresponding location on the passenger's side of the autonomous vehicle 100. Additional radar units and cameras (not shown) may be located at the front and rear ends of autonomous vehicle 100 and/or on other positions along the roof or rooftop housing 310.

Computing devices 110 may be capable of communicating with various components of the vehicle in order to control the movement of autonomous vehicle 100 according to primary vehicle control code of memory of computing devices 110. For example, returning to FIG. 1, computing devices 110 may include various computing devices in communication with various systems of autonomous vehicle 100, such as deceleration system 160, acceleration system 162, steering system 164, signaling system 166, planning system 168, routing system 170, positioning system 172, perception system 174, behavior modeling system 176, and power system 178 (i.e. the vehicle's engine or motor) in order to control the movement, speed, etc. of autonomous vehicle 100 in accordance with the instructions 134 of memory 130.

The various systems of the vehicle may function using autonomous vehicle control software in order to determine how to control the vehicle. As an example, a perception system software module of the perception system 174 may use sensor data generated by one or more sensors of an autonomous vehicle, such as cameras, Lidar sensors, radar units, sonar units, etc., to detect and identify objects and their characteristics. These characteristics may include location, type, heading, orientation, speed, acceleration, change in acceleration, size, shape, etc.

In some instances, characteristics may be input into a behavior prediction system software module of the behavior modeling system 176 which uses various behavior models based on object type to output one or more behavior predictions or predicted trajectories for a detected object to follow into the future (e.g., future behavior predictions or predicted future trajectories). In this regard, different models may be used for different types of objects, such as pedestrians, bicyclists, vehicles, etc. The behavior predictions or predicted trajectories may be a list of positions and orientations or headings (e.g., poses) as well as other predicted characteristics such as speed, acceleration or deceleration, rate of change of acceleration or deceleration, etc.

In other instances, the characteristics from the perception system 174 may be put into one or more detection system software modules, such as a traffic light detection system software module configured to detect the states of known traffic signals, construction zone detection system software module configured to detect construction zones from sensor data generated by the one or more sensors of the vehicle as well as an emergency vehicle detection system configured to detect emergency vehicles from sensor data generated by sensors of the vehicle. Each of these detection system software modules may use various models to output a likelihood of a construction zone or an object being an emergency vehicle.

Detected objects, predicted trajectories, various likelihoods from detection system software modules, the map information identifying the vehicle's environment, position information from the positioning system 170 identifying the location and orientation of the vehicle, a destination location or node for the vehicle as well as feedback from various other systems of the vehicle may be input into a planning system software module of the planning system 168. The planning system 168 may use this input to generate planned trajectories for the vehicle to follow for some brief period of time into the future based on a route generated by a routing module of the routing system 170. Each planned trajectory may provide a planned path and other instructions for an autonomous vehicle to follow for some brief period of time into the future, such as 10 seconds or more or less. In this regard, the trajectories may define the specific characteristics of acceleration, deceleration, speed, direction, etc. to allow the vehicle to follow the route towards reaching a destination location. A control system software module of computing devices 110 may be configured to control movement of the vehicle, for instance by controlling braking, acceleration and steering of the vehicle, in order to follow a trajectory.

The computing devices 110 may control the vehicle in one or more of the autonomous driving modes by controlling various components. For instance, by way of example, computing devices 110 may navigate the vehicle to a destination location completely autonomously using data from the detailed map information and planning system 168. Computing devices 110 may use the positioning system 170 to determine the vehicle's location and perception system 174 to detect and respond to objects when needed to reach the location safely. Again, in order to do so, computing device 110 and/or planning system 168 may generate trajectories and cause the vehicle to follow these trajectories, for instance, by causing the vehicle to accelerate (e.g., by supplying fuel or other energy to the engine or power system 178 by acceleration system 162), decelerate (e.g., by decreasing the fuel supplied to the engine or power system 178, changing gears, and/or by applying brakes by deceleration system 160), change direction (e.g., by turning the front or rear wheels of autonomous vehicle 100 by steering system 164), and signal such changes (e.g., by lighting turn signals) using the signaling system 166. Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

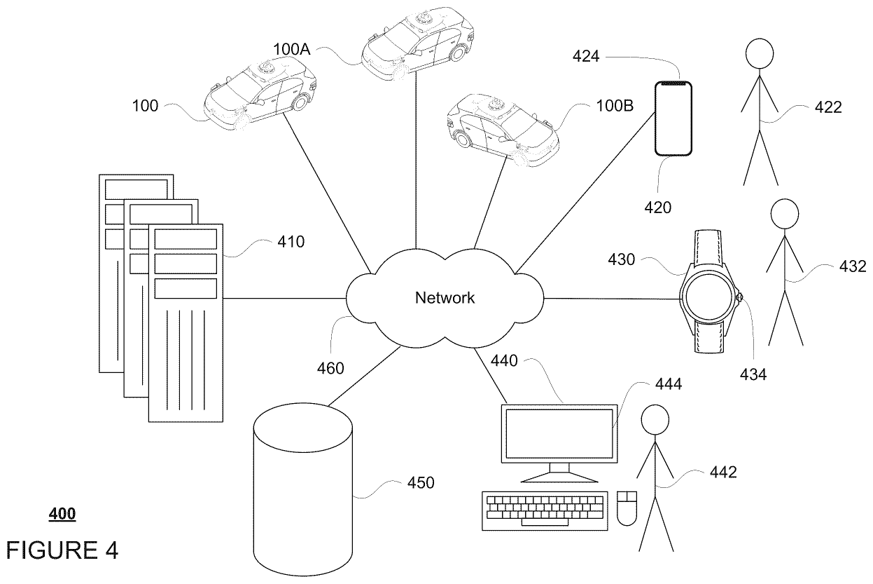

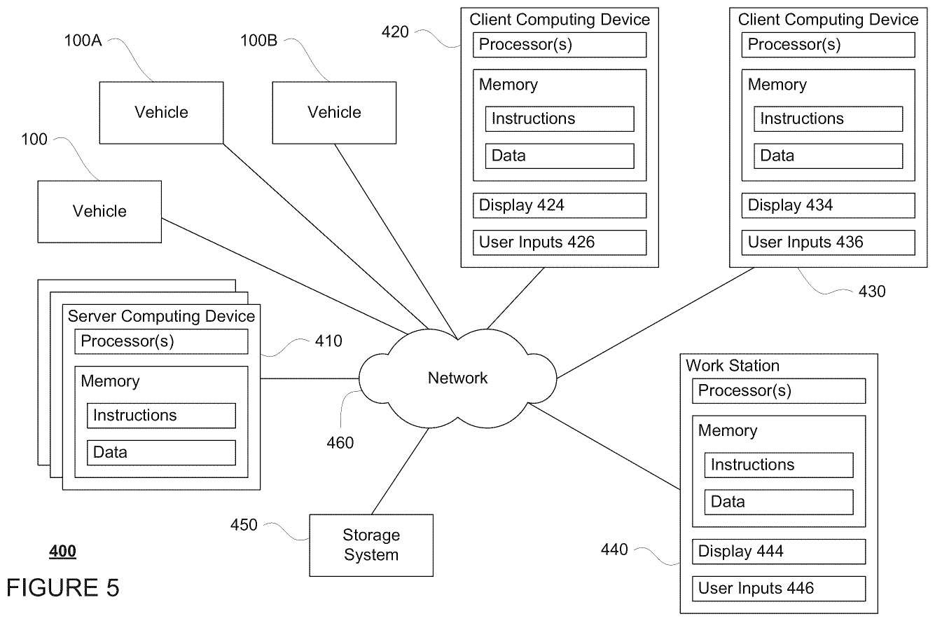

Computing device 110 of autonomous vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440 and a storage system 450 connected via a network 460. System 400 also includes autonomous vehicle 100A and autonomous vehicle 100B, which may be configured the same as or similarly to autonomous vehicle 100. Although only a few vehicles and computing devices are depicted for simplicity, a typical system may include significantly more.

As shown in FIG. 5, each of computing devices 410, 420, 430, 440 may include one or more processors, memory, data and instructions. Such processors, memories, data and instructions may be configured similarly to one or more processors 120, memory 130, data 132, and instructions 134 of computing device 110.

The network 460, and intervening graph nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of autonomous vehicle 100 or a similar computing device of autonomous vehicle 100A or autonomous vehicle 100B as well as computing devices 420, 430, 440 via the network 460. For example, autonomous vehicles 100, 100A, 100B, may be a part of a fleet of vehicles that can be dispatched by server computing devices to various locations. In this regard, the server computing devices 410 may function as a scheduling system which can be used to arrange trips for passengers by assigning and dispatching vehicles such as autonomous vehicles 100, 100A, 100B. These assignments may include scheduling trips to different locations in order to pick up and drop off those passengers. In this regard, the server computing devices 410 may operate using scheduling system software in order to manage the aforementioned autonomous vehicle scheduling and dispatching. In addition, the computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 4, each client computing device 420, 430 may be a personal computing device intended for use by a user 422, 432 and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, such as a wristwatch as shown in FIG. 3. As an example, the user may input information using a small keyboard, a keypad, microphone, using visual signals with a camera, or a touch screen. As yet another example, client computing device 440 may be a desktop computing system including a keyboard, mouse, camera and other input devices.

In some examples, client computing device 420 may be a mobile phone used by a passenger of an autonomous vehicle. In other words, user 422 may represent a passenger or a scheduler as discussed herein. In addition, client computing device 430 may represent a smart watch for a passenger of an autonomous vehicle. In other words, user 432 may represent a passenger or a scheduler as discussed herein. The client computing device 440 may represent a workstation for an operations person, for example, a remote assistance operator or other operations personnel who may provide remote assistance to an autonomous vehicle and/or a passenger. In other words, user 442 may represent an operator (e.g. operations person) of a transportation service utilizing the autonomous vehicles 100, 100A, 100B. Although only a few passengers, schedulers and operations persons are shown in FIGS. 4 and 5, any number of such passengers and remote assistance operators (as well as their respective client computing devices) may be included in a typical system.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4, and/or may be directly connected to or incorporated into any of computing devices 110, 410, 420, 430, 440, etc.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

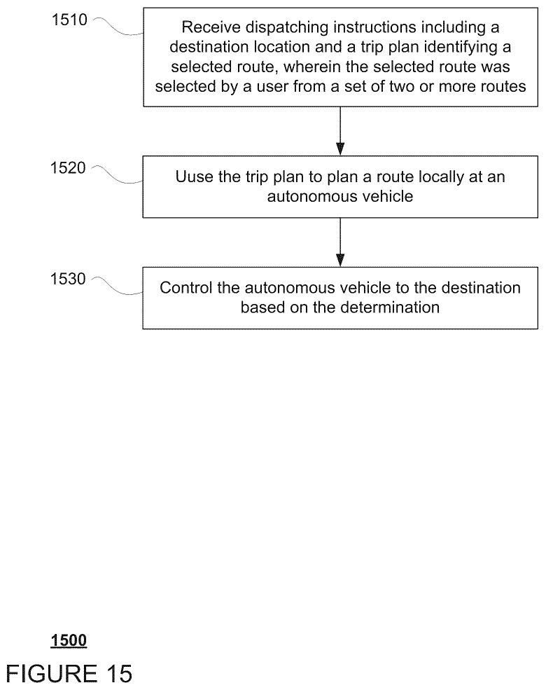

FIG. 15 provides an example flow diagram 1500 for controlling an autonomous vehicle, which may be performed by one or more processors, such as the one or more processors of the computing devices 110. As shown in block 1510, dispatching instructions including a destination location and a trip plan identifying a selected route are received. The route was selected by a user from a set of two or more routes.

As noted above, when a user sets up a trip, the user may select from a set of possible routes. In one aspect in order to do so, a user may download an application for requesting a vehicle to a client computing device. For example, users 422 and 432 may download the application via a link in an email, directly from a website, or an application store to client computing devices 420 and 430. For example, a client computing device may transmit a request for the application over the network 460, for example, to one or more server computing devices 410, and in response, receive the application. The application may then be installed locally at the client computing device.

To arrange a trip, a user, such as user 422, may first use a client computing device, such as client computing device 420, to arrange a trip. For instance, the user 422 may access an application of the transportation service and view an option to arrange a trip. The user may also specify or otherwise provide a pickup location at which a vehicle can pick up the vehicle. In response, the client computing device 420 may send a request to a server computing device identifying at least a pickup location (e.g., a current location of the client computing device) and in some instances a different drop off destination.

As an example, a pickup location can be selected by defaulting to a current location of the passenger's client computing device, but may also be a recent, suggested, or saved location near the current location associated with the user's account. The user may enter an address or other location information, tap a location on a map or select a location from a list in order to identify a pickup location. For instance, the client computing device 420 by way of the application may send its current location, such as a GPS location, and/or a name, address or other identifier for the pickup location to the one or more server computing devices 410 via network 460. In this regard, the user may share his or her current location (or other information such as accelerometer or gyroscope information generated by such devices at the client computing device) with the server computing devices 410 when using the application and/or requesting a vehicle for a trip.

The user may also select or specify a drop off or destination location in a similar manner. For example, a destination location be a recent, suggested, or saved location near the current location associated with the user's account. The user may enter an address or other location information, tap a location on a map or select a location from a list in order to identify a pickup location.

The application may provide the user's selected pickup location and destination location to the server computing devices 410. These server computing devices may use the locations to determine a set of routes. Typically, the routing system of the server computing devices may search for an optimal route between two locations which has the best (e.g., lowest) overall cost based on a combination of attributes (e.g., shortest route with the least amount of turns where the autonomous vehicle reaches a location on the desired side of the street, avoid difficult maneuvers like three-point turns, etc.). In order to generate alternative routes that differ from the optimal route in a non-trivial way, the alternative routes may be selected based on specific attributes. For example, in addition to the optimal route, the set of routes may also include routes that have the fewest number of turns, shortest route in terms of time, shortest route in terms of driving distance, etc.

In some instances, the set of routes may be determined based on the alternative routes that are generated automatically when performing the route searches by the routing system to find the optimal route. For example, one algorithm may perform a plurality of forward searches from a closest node to the user's selected pickup location and backwards or reverse searches from a closest node to the user's selected destination location on map information (e.g., by searching through the nodes and edges of the roadgraph) in order to identify locations or specific graph nodes where the searches meet or “vias”.

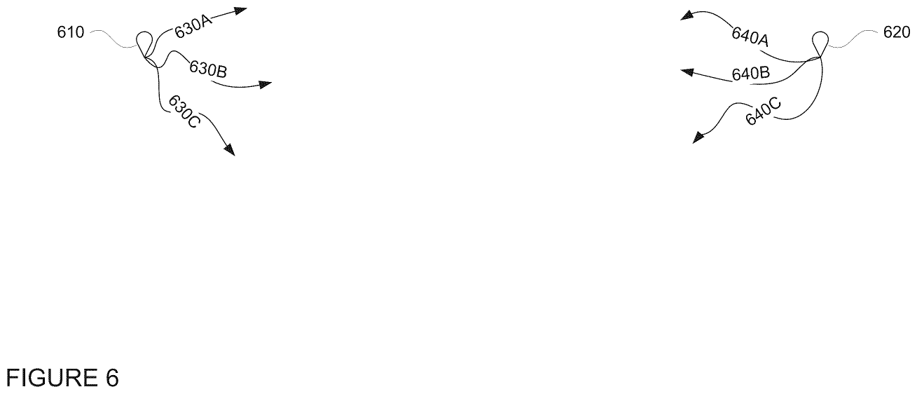

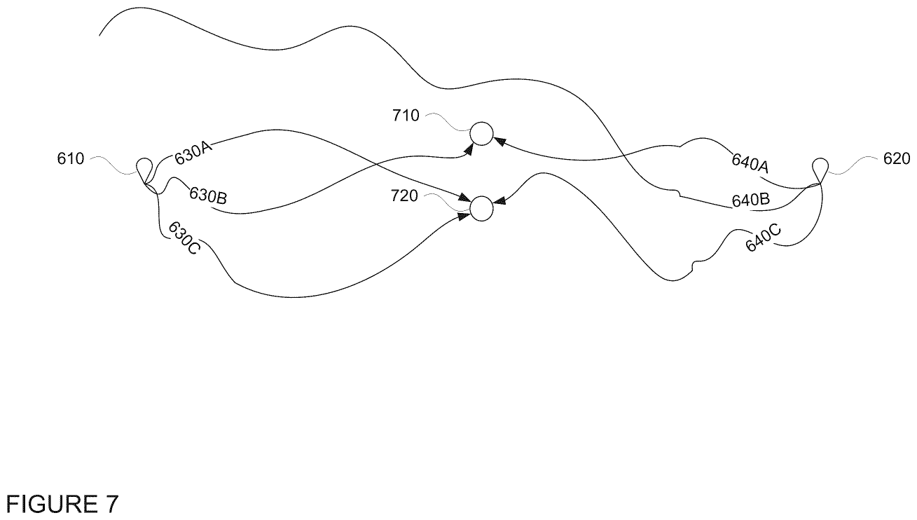

For example, FIG. 6 is a visual representation of such searches from a pickup location 610 and a destination location 620 for ease of understanding. Each search line 630A-C, represents a different search from the pickup location through the road graph (not depicted), and each search line 640A-C represents a different search from the destination location through the road graph. Although only a few search lines are depicted, a given route search may include dozens, hundreds, thousands, tens of thousands or more individual searches. Turning to FIG. 7, these searches may meet at a plurality of “vias” represented by open circles 710, 720 or nodes in the road graph through which at least one forward search and at least one backward search meet. In some examples, some searches, such as that represented by search line 640A, may end (e.g., time out) without ever reaching a via.

These vias may form the basis of the set of routes. For instance, for each via the shortest path (e.g., shortest distance, fewest number of nodes and/or edges, etc.) from the pickup location to the via and from the via to the destination location may be a single route. As an example, each edge in the road graph may be associated with a predefined cost. These costs may be summed across the paths to determine the shortest path between the pickup location and the via and between the destination location and the via. The number of vias may be determined based on limits for the searching algorithm and may therefore be adjusted in order to increase or decrease the number of vias. However, because the number of vias may be fairly large compared to the desired number of routes in the set (e.g., 30 vias vs. 3 or 4 routes to be displayed to the user), certain routes may be excluded or the set may be filtered.

Different approaches may be used by the server computing devices 410 in order to limit the number of routes in the set of routes. For instance, the optimal route may always be included in the set and various combinations of different requirements may be used to exclude or filter routes that are too similar or otherwise not desirable. As an example, between two routes with greater than 75% overlap or with 25% or less difference in road segment identifiers, the route with the greater cost may be excluded. As another example, between two routes with greater than 75% difference in distance or with 25% or less difference in distance, the route with the greater cost may be excluded. Of course, greater or lesser thresholds may be used depending upon the service areas (e.g., some geographic areas may have greater likelihoods of overlap if there are fewer options) and needs of the transportation service.

For another instance, routes which are otherwise not desirable because they are simply too long or require certain types of maneuvers may be excluded or filtered by the server computing devices 410. As another example, alternative routes that have greater than 135% difference in estimated time of arrival at the destination location as compared to the optimal route may be excluded. Again, greater or lesser thresholds may be used depending upon the service areas (e.g., some geographic areas may have greater likelihoods of overlap if there are fewer options) and needs of the transportation service. As another example, alternative routes having certain attributes or maneuvers, such as loops where an autonomous vehicle takes a highway exit, does a U-turn, and gets back on a highway, may be excluded.

Other attributes may be used by the server computing devices 410 to include a particular alternative route in the set of routes. For example, the optimal route, or the route with the lowest cost, may be included in the set of routes. In addition, routes that have been selected by this user or other users of the transportation service in the past may be included. Other examples may include routes that go on or avoid highways, routes that go on or avoids tolls, routes that are long and winding or scenic (for tourists in the city), routes that are more eco-friendly, routes that avoid going into neighborhoods unless absolutely necessary (by staying on main thoroughfares), and routes with fewer turns (i.e., route looks more pleasing to the eye if that ends up taking up more time), etc.

In addition, or alternatively, because the optimal route is selected using a cost function, a bound may be set by the server computing devices 410 on the cost function so that the alternative routes do not include routes that more holistically are too different, have difficult maneuvers, and/or are too penalized (e.g., too high a cost). In this regard, routes that are within a certain cost difference (e.g., greater than 25% or more or less) from the optimal route may be included in the set. This in effect may put a limit on how suboptimal the alternative routes in the set are. In addition, or alternatively, an additional cost or negative cost may be added to a route depending on whether or not the route has been provided to a user of the transportation service in the past and whether or not the route has been selected by the user. In this regard, previously unselected routes may therefore have higher costs (by adding an additional cost) and/or previously selected routes may have lower costs (by adding a negative cost).

The server computing devices 410 may send the set of routes to the user's client computing device for display. In some instances, the routes may be displayed with attributes for each route, such as “shortest route”, “fewer turns”, “no tolls”, “previously selected” (for example, for a route between these locations which was previously selected by the user), etc. The user may select one of the routes or alternatively, if a route is not affirmatively selected, a default route (e.g., the optimal route) may be automatically selected. In this regard, users who prefer not to select a particular route may not be required to do so. The client computing device may then send a signal to the server computing device identifying the selected route.

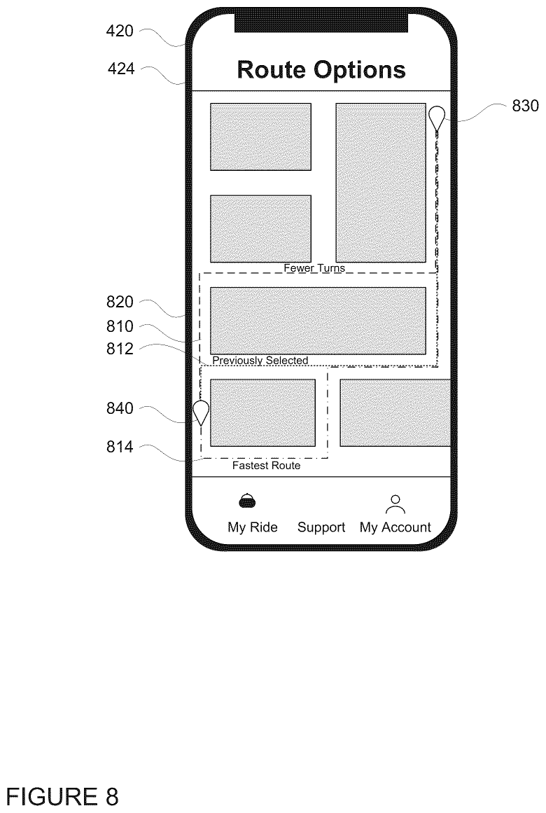

FIG. 8 provides an example of client computing device 420 displaying a set of routes 810, 812, 814 on display 424. In this example, the routes 810, 812, 814 may have been provided to the client computing device 420 by the server computing devices 410 for display. In this example, the routes are depicted with respect to a map 820 including the pickup location marker 830 identifying the user's selected pickup location and destination location marker 840 identifying the user's selected destination location. Each of the routes is also displayed with an attribute label, which identifies an attribute for that route. For example, route 810 includes a fewer turns route attribute label, route 812 includes a previously selected attribute label, and route 814 includes a fastest route attribute.

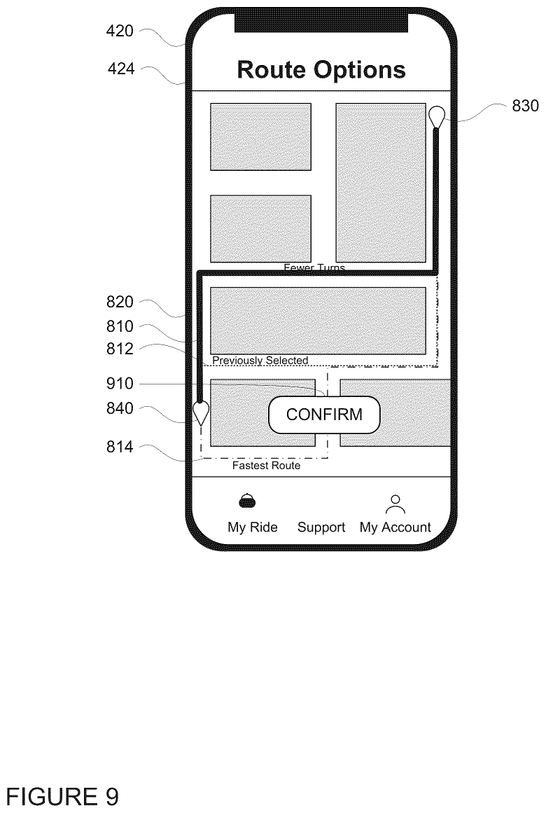

Once a route has been selected, for example, by tapping on the display 424, the route may be highlighted and the user may be requested to confirm the selection. For example, turning to FIG. 9, route 810 has been selected (now shown as thicker in line), and the user is asked to confirm the selection, for example, by selecting the “CONFIRM” option 910. Once the user selects this option, the processors of the client computing device 420 may send a signal to the server computing device 410 identifying the route 810.

The server computing devices 410 may then send dispatching instructions to an autonomous vehicle, such as autonomous vehicle 100, in order to cause the autonomous vehicle to travel to the pickup location in order to pick up the user (now passenger) and transport the passenger to the destination location. The server computing devices 410 may also provide the autonomous vehicle with a trip plan. In this regard, the computing devices 110 (e.g., by way of the processors 120) may receive the dispatching instructions including the trip plan from the server computing devices 410.

The trip plan may include information that can be used by the autonomous vehicle, or rather the routing system 170, to generate and determine routes for the autonomous vehicle 100 to follow to the user's selected destination location. In this regard, as noted above, once the user has been picked up at the pickup location, the routing system may plan or generate routes to the user's selected destination from the current location of the autonomous vehicle. In this regard, the routing system may plan or generate routes in real time, locally at the autonomous vehicle.

In some instances, the trip plan may include a list of identifiers for edges and/or nodes in the map information which when connected in order correspond to the route. For example, returning to the example of FIG. 9, the server computing devices 410 may receive information identifying the route 810. In response, the server computing devices 410 may include a list of identifiers for each of the edges and/or nodes of the roadgraph that make up the route 810 in the dispatching instructions.

In addition, or alternatively, the information of the trip plan may include a list of geographic locations (e.g., points corresponding to locations within map information, such as latitude and longitude coordinates or other map coordinates) which when connected in order with the pickup location, via, and destination location correspond to the route. As an example, these geographic locations may be separated by a fixed distance, such as 20 meters or more or less. Alternatively, these geographic locations may correspond to the geographic locations of the nodes that make up the route (i.e., without utilizing the identifiers for the nodes). This may be especially useful in situations in which the map information is continuously updated and the road segments, nodes and identifiers may be changed over time.

Returning to FIG. 15, at block 1520, the trip plan is used to plan a route. For instance, the computing devices 110 and/or the routing system 170 may then use the trip plan to plan a route between the pickup location and destination location. However, because the autonomous vehicle 110 has its own routing system that the autonomous vehicle may use periodically (e.g., several times a second or more or less) to recalculate the optimal route, if the selected route is not or no longer the optimal route, the autonomous vehicle may deviate from the selected route. To avoid this, different enforcement approaches may be used.

As one enforcement approach, the aforementioned information for the trip plan may also identify the via of the selected route as well as a cost of the selected route, a cost of the optimal route (i.e., a route that had the lowest overall cost), and/or the cost difference between the cost of the selected route and the cost of the optimal route. The routing system 170 may find the shortest route to the closest node to the user's selected destination location by concatenating the shortest route from a current location of the autonomous vehicle 100 (e.g., provided by the positioning system 172) to the via and the shortest route from the via to the closest node to the user's selected destination location. If at any time the shortest route to the via exceeds the cost difference between the cost of the selected route and the cost of the optimal route plus an additional cost, then the routing system 170 can go back to finding the shortest route directly to the closest node to the user's selected destination location instead of to the via. The magnitude of this additional cost may define how costly the selected route must become in order to allow the autonomous vehicle to deviate from the selected route and may be tuned depending upon the needs of the transportation service. For example, if the autonomous vehicle 100 approaches a via which has become blocked for some reason, e.g., due to previously unknown construction, a parked vehicle, or some other obstacle in the roadway, etc., this may allow the routing system 170 to route the autonomous vehicle 100 around the blockage because the cost of the selected route would increase such that it might be greater than the additional cost.

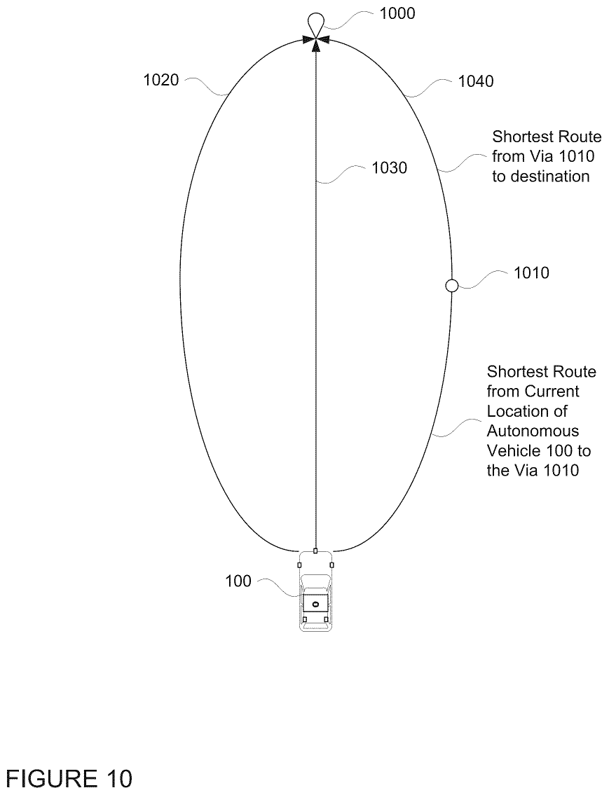

FIG. 10 provides a visual representation of the above-described enforcement approach and includes routes 1020, 1030, 1040 from the current location of the autonomous vehicle 100 to the user's selected destination which may have been generated by the routing system 170. In this example, the server computing devices 410 may provide the computing devices 110 with via 1010 which may be the via of the route selected by the user (e.g., the via of route 810 of FIGS. 8 and 9). In this example, the routing system 170 may determine the shortest route from the current location of the autonomous vehicle 100 to the via 1010 and the shortest route from the via 1010 to the node closest to the user's selected destination location represented by marker 1000. Together, these may form route 1040. The routing system 170 may determine the cost of this route (e.g., by summing the costs of the edges). If this cost exceeds the original cost, then the routing system 170 may determine additional routes (e.g., routes 1020, 1030). The routing system 170 may select the route having the lowest cost.

As another enforcement approach, the trip plan may also include the vias for each of the unselected routes of the set of routes. This may enable the routing system 170 to add an additional cost to routes or any edges within the road graph that are within a radial distance around each via of the routes of the set of routes that were not selected. As an example, the radial distance may be 10 meters, 20 meters or more or less. The magnitude of this additional cost may define how costly the selected route must become in order to allow the autonomous vehicle to deviate from the selected route and may be tuned depending upon the needs of the transportation service. However, this enforcement approach may allow for some trivial differences from the selected route (e.g., new vias that are not identified in the trip plan but are nearby the selected route). To address this, these new vias may also be penalized or filtered by the routing system. Again, in this example, if the autonomous vehicle approaches a via which has become blocked for some reason, e.g., due to previously unknown construction, a parked vehicle, etc., this may allow the autonomous vehicle to route around the blockage because the cost of the selected route would increase such that it might be greater than the additional cost.

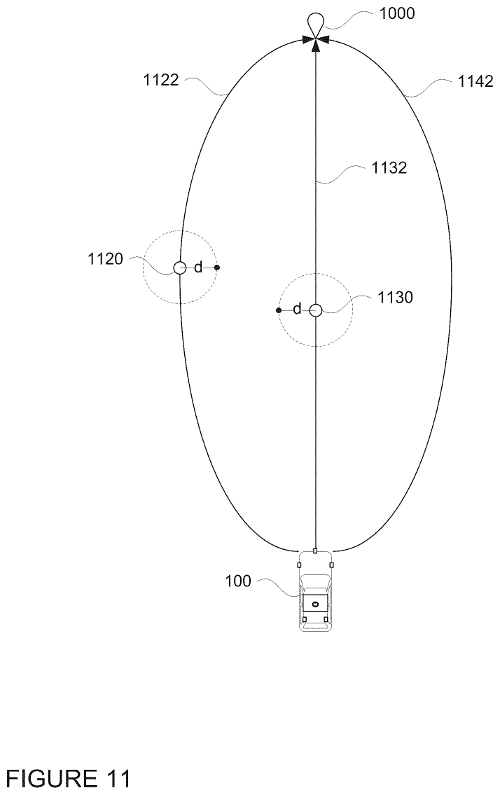

FIG. 11 provides a visual representation of the above-described enforcement approach and includes routes 1122, 1132, 1142 from the current location of the autonomous vehicle 100 to the user's selected destination which may have been generated by the routing system 170. In this example, the server computing devices 410 may provide the computing devices 110 with vias 1120, 1130 which may be the via of the routes not selected by the user (e.g., the via of routes 812 and 814 of FIGS. 8 and 9). In this example, the routing system 170 may add a penalty or an additional cost any routes and/or edges of the map information which pass within a predetermined distance d of the vias 1120, 1130. In this regard, the additional costs may increase the overall costs of routes 1122 and 1132, but not route 1142. The routing system 170 may then select the route having the lowest overall cost.

As another enforcement approach, the trip plan may also include the list of geographic locations for each of the unselected routes of the set of routes. This may enable the routing system 170 to add an additional cost for any routes or edges in the map information that pass through an area around any of the geographic locations for each of the unselected routes of the set of routes. These areas may be defined by a radial distance. As an example, the radial distance may be 10 meters, 20 meters or more or less. Because the number of geographic locations for each route may be a relatively large number, this additional cost may be fairly small compared to the additional costs in the enforcement approaches described above. In addition, the routing system 170 may not apply the penalty to any of the geographic locations which are also on the selected route. This enforcement approach may be preferred over the prior enforcement approaches because the additional cost is applied to a plurality of geographic locations rather than one or more specific vias.

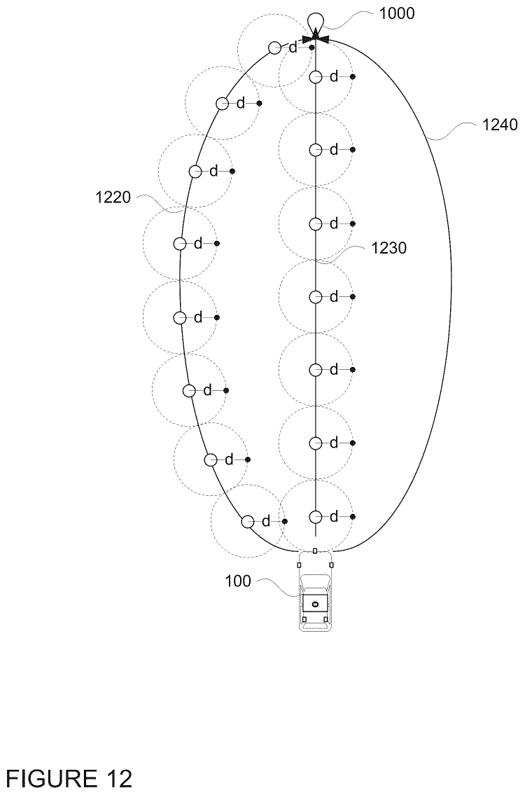

FIG. 12 provides a visual representation of the above-described enforcement approach and includes routes 1220, 1230, 1240 from the current location of the autonomous vehicle 100 to the user's selected destination which may have been generated by the routing system 170. In this example, the server computing devices 410 may provide the computing devices 110 with a list of geographic locations (represented by the open circles along routes 1220, 1230, respectively) corresponding to the routes not selected by the user (e.g., the via of routes 812 and 814 of FIGS. 8 and 9). In this example, route 1220 may correspond to the route 812, and route 1230 may correspond to the route 814. The routing system 170 may add a penalty or an additional cost any routes and/or edges of the map information which pass within the predetermined distance d of the vias of the routes 1220 and 1230. In this regard, the additional costs may increase the overall costs of routes 1220 and 1230, but not route 1240. The routing system 170 may then select the route having the lowest overall cost.

As another enforcement approach, as an alternative to adding an additional cost to vias or geographic locations as described above, a discount in cost may be added to the via and/or any of the geographic locations of the selected route. This may enable the routing system 170 to encourage the routing system to select routes that pass through the via or any of the geographic locations of the selected route. Again, the magnitude of this discount may define how costly the selected route must become in order to allow the autonomous vehicle to deviate from the selected route and may be tuned depending upon the needs of the transportation service. This discount may be implemented as a negative cost in summation with any other costs, under the constraint that the total cost is non-negative, to avoid negative-cost cycles in the route planning system. In order to avoid an overall cost for a route which is a negative value, the cost function may be configured to go to zero for any negative values. This may be represented by the following equation: new_cost=max(old_cost−discount, 0). In this example, old_cost corresponds to the original cost of an edge or route, new_cost corresponds to the new cost of an edge or route that passes through an area within the predetermined distance of the via or geographic locations of the selected route, and discount corresponds to the negative cost. Again, in this example, if the autonomous vehicle 100 approaches a via or other geographic location along its current route which has become blocked for some reason, e.g., due to previously unknown construction, a parked vehicle, etc., this enforcement approach may allow the autonomous vehicle to route around the blockage. This may be because the cost of the selected route would increase such that it may negate the negative cost, and in such instances another route may be published to other systems of the autonomous vehicle by the routing system 170.

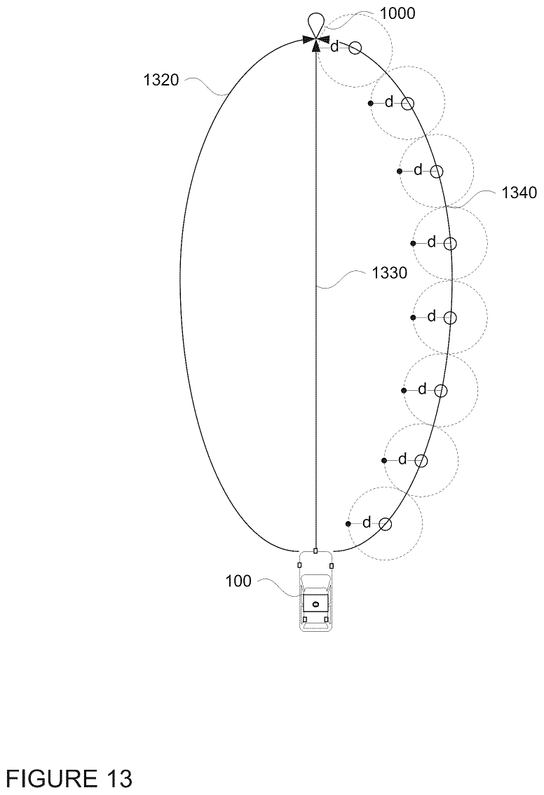

FIG. 13 provides a visual representation of the above-described enforcement approach and includes routes 1320, 1330, 1340 from the current location of the autonomous vehicle 100 to the user's selected destination which may have been generated by the routing system 170. In this example, the server computing devices 410 may provide the computing devices 110 with vias or geographic locations of the selected route (e.g., the via or geographic locations of the selected route 810 of FIGS. 8 and 9). In this example, route 1340 may correspond to the route 810. The routing system 170 may add a negative cost to any routes and/or edges of the map information which pass within the predetermined distance d of the vias or geographic location of the route 810. In this regard, the negative costs may decrease the overall costs of route 1340, but not routes 1320 and 1330. The routing system 170 may then select the route having the lowest overall cost.

Returning to FIG. 15, at block 1530, the autonomous vehicle is controlled to the destination based on the determination. For instance, based on whichever enforcement approach is used, the routing system may generate a route as described in the examples above, and the various systems of the autonomous vehicle may use the route to determine how to control the autonomous vehicle (e.g., generate trajectories, control braking, acceleration, steering, etc.).

Because the rerouting may occur while the user (now passenger) is within the autonomous vehicle, when a new route is published by the routing system, the autonomous vehicle's computing devices may automatically provide a notification, for example, on an internal display of the autonomous vehicle, such as internal electronic display 152, to indicate the change. As an example, the notification may indicate that the autonomous vehicle has made a reasonable effort to follow the selected route, but could not do so and thus, the route has changed. In some instances, this notification may be prompted, for example, by a signal from the server computing devices 410 to the computing devices 110 once the autonomous vehicle sends the new route to the server computing devices 410 (e.g., via a status update message).

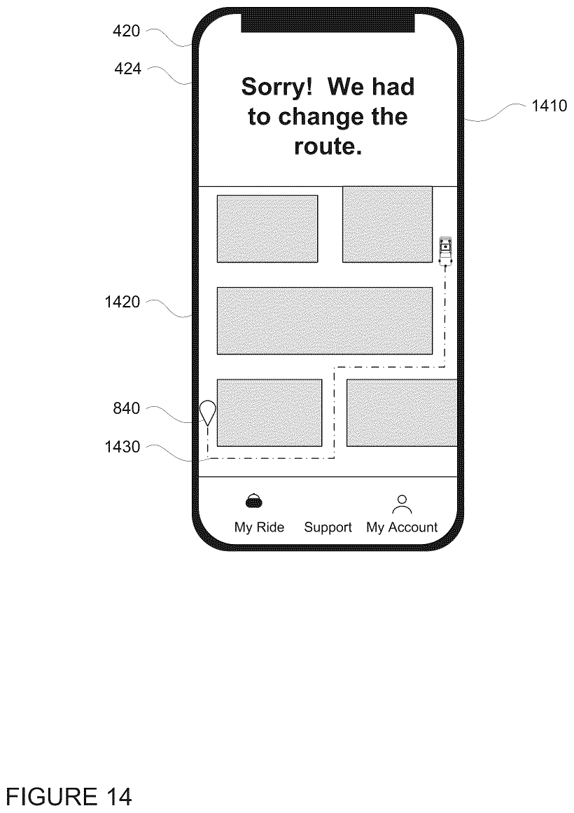

FIG. 14 provides an example of client computing device 420 displaying a notification 1410 on display 424. In this example, the notification indicates that the route the autonomous vehicle 100 is following has changed. In this example, a map 1420 is displayed with a new route 1430 to the user selected destination represented by marker 840.

The knowledge of which routes were selected and not selected by users of the transportation service may be used to inform decision making for the transportation service. For instance, as noted above, an additional cost or negative cost may be added by the server computing devices 410 to a route depending on whether or not the route has been provided to a user of the transportation service in the past and whether or not the route has been selected by the user. In this regard, previously unselected routes may therefore have higher costs (by adding an additional cost) and/or previously selected routes may have lower costs (by adding a negative cost and also adjusting to zero if the new cost is negative). In addition, selected and unselected routes may be analyzed to determine which attributes are more likely to cause a user to select or not select different routes. Such an analysis may identify whether attributes such as the number of turns, the number of complex or certain types of maneuvers, certain geographic areas, roads with certain numbers of lanes, fewer stop signs or traffic lights, etc. are more or less influential in the selections by user.

This, in turn, may be used to tune the cost function for selecting the optimal route. Over many users, this information could be used to guide automated approaches to figure out the most pleasing global set of attributes or cost values for different routes. For instance, such information could select a value for a new cost by evaluating different values over a plurality of different routes. The cost values which produce optimal routes which most closely align with what users have selected in the past may be used to evaluate future routes.

Moreover, the usefulness of each of the enforcement approaches may be analyzed. For example, successfulness (S) in an autonomous vehicle following the selected route may be computed by determining the fraction of trips which traveled within some distance (such as 10 meters, 20 meters or more or less) of the via of the selected route (V) over the total number of trips for which users had a choice of routes (T) or S=V/T. The value of S may therefore be a proxy for how well the enforcement approaches fair in enforcing selected routes. This, in turn, may be used to select the best enforcement approach for a particular transportation service, service area, configuration of autonomous vehicles (e.g., software or hardware version), etc.

The features described herein may enable passengers to select routes for an autonomous vehicle to follow as well as enforce those selected routes while at the same time enabling autonomous vehicles to deviate from the selected routes when necessary. Because multiple different routes are provided to a user at the time a trip is arranged, the transportation service is more likely to present the user with a route that the user likes. This may therefore account for a user's personal preferences and may also provide the user with some feeling and actual control over the trip beyond the pickup and destination locations. Moreover, the different enforcement approaches provided herein may enable flexible enforcement of a selected route which meets the needs of a particular transportation service.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only some of many possible embodiments. Further, the same reference numbers in different drawings can identify the same or similar elements.

1. A method of controlling an autonomous vehicle, the method comprising:
receiving, by one or more processors, dispatching instructions including a destination location and a trip plan identifying aspects of a selected route, wherein the selected route was selected by a user from a set of two or more routes;
using, by the one or more processors, the trip plan to plan a route locally at the autonomous vehicle; and
controlling, by the one or more processors, the autonomous vehicle to the destination location based on the planned route.

2. The method of claim 1, wherein the trip plan further identifies a plurality of identifiers for road segments which when connected together with a pickup location and the destination location correspond to the selected route.

3. The method of claim 1, wherein the trip plan further identifies a plurality of geographic locations which when connected together with a pickup location and the destination location correspond to the selected route.

4. The method of claim 3, wherein two or more of the plurality of geographic locations are a fixed distance from one another.

5. The method of claim 1, wherein the trip plan further identifies a geographic location between the pickup location and the destination location on the selected route, and the method further comprises:
generating routes based on a current location of the autonomous vehicle and the destination location; and
determining costs for the generated routes by adding an additional cost to each of the generated routes which do not pass through the identified geographic location, and wherein determining whether to use the selected route or a new route is based on the determined costs.

6. The method of claim 1, wherein the trip plan further identifies a geographic location between a pickup location and the destination location for each route of the set of routes, and the method further comprises:
generating routes based on a current location of the autonomous vehicle and the destination location; and
determining costs for the generated routes by adding an additional cost to each of the generated routes which pass through the identified geographic locations for routes of the set of routes other than the selected route, and wherein determining whether to use the selected route or a new route is based on the determined costs.

7. The method of claim 1, wherein the trip plan further identifies a plurality of geographic locations for each given route of the set of routes which when connected together with a pickup location and the destination location correspond to the given route, and the method further comprises:
generating routes based on a current location of the autonomous vehicle and the destination location; and
determining costs for the generated routes by adding an additional cost to each of the generated routes which pass within a radial distance of any of the identified geographic locations for routes of the set of routes, and wherein determining whether to use the selected route or a new route is based on the determined costs.

8. The method of claim 1, wherein the trip plan further identifies a plurality of geographic locations for each given route of the set of routes which when connected together with a pickup location and the destination location correspond to the given route, and the method further comprises:
generating routes based on a current location of the autonomous vehicle and the destination location; and
determining costs for the generated routes by adding an additional cost to each of the generated routes which pass within a radial distance of any of the identified geographic locations for routes of the set of routes other than the selected route, and wherein determining whether to use the selected route or a new route is based on the determined costs.

9. The method of claim 1, wherein the trip plan further identifies a geographic location between a pickup location and the destination location on the selected route, and the method further comprises:
generating routes based on a current location of the autonomous vehicle and the destination location; and
determining costs for the generated routes by adding a negative cost to each of the generated routes which pass through the identified geographic location, and wherein determining whether to use the selected route or a new route is based on the determined costs.

10. A system for controlling an autonomous vehicle, the system comprising one or more processors configured to:
receive dispatching instructions including a destination location and a trip plan identifying a selected route, wherein the selected route was selected by a user from a set of two or more routes;
use the trip plan to plan a route locally at the autonomous vehicle; and
control the autonomous vehicle to the destination location based on the determination.

11. The system of claim 10, wherein the trip plan further identifies a plurality of identifiers for road segments which when connected together with a pickup location and the destination location correspond to the selected route.

12. The system of claim 10, wherein the trip plan further identifies a plurality of geographic locations which when connected together with a pickup location and the destination location correspond to the selected route.

13. The system of claim 12, wherein two or more of the plurality of geographic locations are a fixed distance from one another.

14. The system of claim 10, wherein the trip plan further identifies a geographic location between a pickup location and the destination location on the selected route, and the one or more processors are further configured to:
generate routes based on a current location of the autonomous vehicle and the destination location; and
determine costs for the generated routes by adding an additional cost to each of the generated routes which do not pass through the identified geographic location, and wherein determining whether to use the selected route or a new route is based on the determined costs.

15. The system of claim 10, wherein the trip plan further identifies a geographic location between a pickup location and the destination location for each route of the set of routes, and the one or more processors are further configured to:
generate routes based on a current location of the autonomous vehicle and the destination location; and
determine costs for the generated routes by adding an additional cost to each of the generated routes which pass through the identified geographic locations for routes of the set of routes other than the selected route, and wherein determining whether to use the selected route or a new route is based on the determined costs.

16. The system of claim 10, wherein the trip plan further identifies a plurality of geographic locations for each given route of the set of routes which when connected together with a pickup location and the destination location correspond to the given route, and the one or more processors are further configured to:
generate routes based on a current location of the autonomous vehicle and the destination location; and
determine costs for the generated routes by adding an additional cost to each of the generated routes which pass within a radial distance of any of the identified geographic locations for routes of the set of routes, and wherein determining whether to use the selected route or a new route is based on the determined costs.

17. The system of claim 10, wherein the trip plan further identifies a plurality of geographic locations for each given route of the set of routes which when connected together with a pickup location and the destination location correspond to the given route, and the one or more processors are further configured to:
generate routes based on a current location of the autonomous vehicle and the destination location; and
determine costs for the generated routes by adding an additional cost to each of the generated routes which pass within a radial distance of any of the identified geographic locations for routes of the set of routes other than the selected route, and wherein determining whether to use the selected route or a new route is based on the determined costs.

18. The system of claim 10, wherein the trip plan further identifies a geographic location between a pickup location and the destination location on the selected route, and the one or more processors are further configured to:
generate routes based on a current location of the autonomous vehicle and the destination location; and
determine costs for the generated routes by adding a negative cost to each of the generated routes which pass through the identified geographic location, and wherein determining whether to use the selected route or a new route is based on the determined costs.

19. The system of claim 10, further comprising the autonomous vehicle.

20. The system of claim 19, further comprising, one or more server computing devices including one or more processors configured to send the dispatching instructions to the one or more processors, and wherein the one or more processors are part of the autonomous vehicle.
